(19) United States
(12) Patent Application Publication
(10) Pub. No.: US 2012/0223172 A1
(43) Pub. Date: Sep. 6, 2012

(54) Twin and Multiple Motor Paper Shredder

(76) Inventor: Guofeng Pan, Dongguan City (CN)

(21) Appl. No.: 13/040,185

(22) Filed: Mar. 3, 2011

(51) Int. Cl. B02C 18/16

(52) U.S. Cl. 241/220

(57) ABSTRACT

A twin and multiple motor paper shredder. Each of the motor relays power through respective gear assembly to the first rotary cutter. Each motor operates at a lower power output and have simpler specification than the conventional motor systems. However, when in combine use, the power output from two or more smaller motor are greater than one single larger motor system and the cost are lower. In this way, manufacturer is able to reduce the production cost, and at the same time, increase the stability and reliability of the paper shredder.

### FIELD OF THE INVENTION

The present invention relates to a power paper shredder, specifically to a power paper shredder having two or more independently operated motor systems powering the shredding mechanism.

### BACKGROUND OF THE INVENTION

Conventional power paper shredder comprises a shredding mechanism and a motor system. The shredding mechanism typically comprising two sets of paralleling rotary cutters each with multiple blades that rotates simultaneously. The motor system is installed at one side of the shredding mechanism for powering the mechanism. The motor system typically comprising a motor and a gear assembly. Conventional power paper shredder requires a high output motor in order to allow the shredding operation to run smoothly and fast. However, high output motors are relatively expensive and hence, making the production of high performance power paper shredders costly. Therefore, present invention provides an improved power paper shredder to overcome the above mentioned shortcomings.

### SUMMARY OF THE INVENTION

The objectives of the present invention is to provides a twin motor or multiple motor paper shredder for which lower output motors can he used and reduce the cost in the production of high performance power paper shredder, at the same time, increases the stability and reliability of the shredder.

In order to achieve the above-mentioned objectives the present invention adopts the following embodiment:

a twin motor paper shredder comprising a shredding mechanism and a first motor and a second motor. The shredding mechanism further comprising two sets of paralleling rotary cutters each with multiple blades that rotates simultaneously. On end of the shredding mechanism a first gear assembly is installed; on the other end of the shredding mechanism a second gear assembly is installed. The first and second gear assembly are connected to the rotary cutters and the first and second motor are connected to the first and second gear assembly respectively. Whereas:

the first and second gear assembly may connected to the same rotary cutter by side end;

the first gear assembly may connected to either one of the rotary cutters by side end and the second gear assembly may connected to the other rotary cutter by side end;

the first and second motor may installed at one side of the shredding mechanism and;

the first and second motor may each installed at one side of the shredding mechanism.

The shredding mechanism of present invention also provides a motor installation space for housing the first and second motor.

Present invention also adopts the following second embodiment:

A multiple motor power paper shredder comprising a shredding mechanism, a first motor, a second motor, at least a third motor, a first gear assembly, a second gear assembly, and at least a third gear assembly. The shredding mechanism is provided with a set of paralleling first and second rotary cutter each with multiple blades. Wherein, the first end side of the first gear assembly connects to the first motor system and the second end side of the first gear assembly connects to the first rotary cutter; the first end side of the second gear assembly connects to the second motor and the second end side of the second gear assembly connects to the first rotary cutter; and the first end side of the third gear assembly connects to the third motor and the second end side of the third gear assembly connects to the first rotary cutter.

The shredding mechanism in this embodiment of present invention also provides at least two or more motor installation space for housing the first second and third motor.

With the forgoing embodiment the present invention takes the advantages over the conventional designs by that: two power sources are employed to power the paper shredder, the first power source comes from an independently operated first motor and first gear assembly; the second power source comes from an independently operated second motor and second gear assembly. Compares to the conventional design, the output power from the first and second motor may be only half of the conventional shredder motor, however, the manufacturer may use smaller and less specified motors in production of the shredder and the combined output from the two smaller motor may be greater than one large motor. In addition, using smaller motors the manufacturers may incur less production cost than the large motor.

Another advantage of the present invention over than conventional power shredder is that since the workload resulting from operation of the rotary cutters are distributed between the first and second gear assembly, the reduced workload of the gear assembly means that the manufacturers may use gears with less grade, which further reduces the production cost. And finally, the present invention has the advantage in providing a power shredder with more stability and reliability when operating.

### BRIEF DESCRIPTION OF THE DRAWINGS

FIG. 1 is a perspective view of the twin motor paper shredder; and

FIG. 2 is another diagrammatic perspective view of the twin motor paper shredder; and

FIG. 3 is a perspective view of the multiple motor paper shredder.

### DETAILED DESCRIPTION OF THE PREFERRED EMBODIMENTS

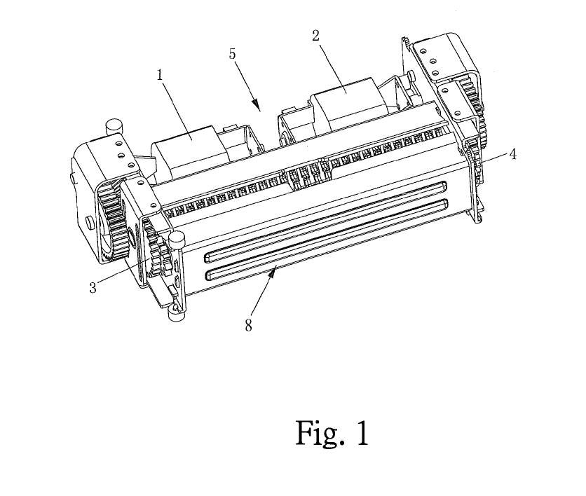

Please refer to FIG. 1 for a first preferred embodiment of the present invention. The first preferred embodiment of the twin motor paper shredder as illustrated in FIG. 1 comprising: a shredding mechanism 8, a first motor 1 and a second motor 2. The shredding mechanism 8 having two sets of paralleling rotary cutters each with multiple blades. On the left and right side of shredding mechanism 8 a first gear assembly 3 and a second gear assembly 4 is installed. The first gear assembly 3 and the second gear assembly 4 connect to the rotary cutter. The shaft of the first motor 1 and second motor 2 connect to the first gear assembly 3 and second gear assembly 4 respectively. Whereas, the first gear assembly 3 and second gear assembly 4 each connects to one same rotary cutter by the side end.

In this first preferred embodiment, the shredding mechanism 8 is powered by two power sources, one of the power source comes from the independently operated first motor 1 and first gear assembly 3; the other power source comes from the independently operated second motor 2 and second gear assembly 4.

Also in this first preferred embodiment, to side of shredding mechanism 8 is provided with a motor installation space 5 housing the first motor 1 and second motor 2.

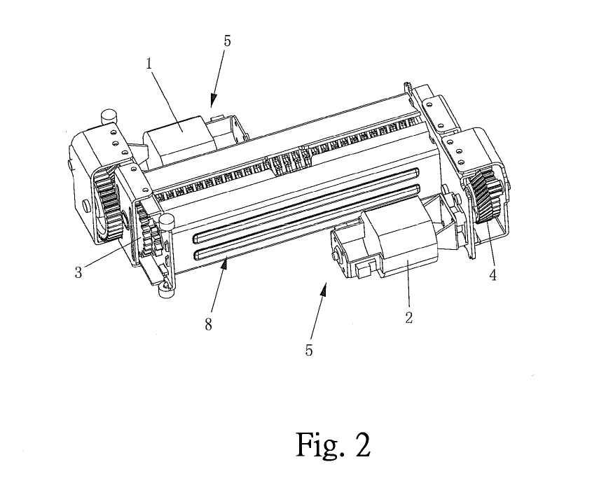

Please refer to FIG. 2 for a second preferred embodiment of the present invention. The second preferred embodiment of the twin motor paper shredder as illustrated in FIG. 2 comprising: a shredding mechanism 8, a first motor 1 and a second motor 2. The shredding mechanism 8 having two sets of paralleling rotary cutters each with multiple blades. On the left and right side of shredding mechanism 8 a first gear assembly 3 and a second gear assembly 4 is installed. The first gear assembly 3 and the second gear assembly 4 connect to the rotary cutter. The shaft of the first motor 1 and second motor 2 connect to the first gear assembly 3 and second gear assembly 4 respectively.

Whereas, the first gear assembly 3 connects to one of the rotary cutters, and the second gear assembly 4 connects to the other rotary cutter.

Whereas, the first motor 1 and second motor 3 are installed at the opposite side of the shredding mechanism 8.

In this second preferred embodiment the shredding mechanism 8 is powered by two power sources, one of the power source comes from the independently operated first motor 1 and first gear assembly 3; the other power source comes from the independently operated second motor 2 and second gear assembly 4.

Also in this second preferred embodiment, to side of shredding mechanism 8 is provided with at two motor installation space 5 housing individually the first motor 1 and second motor 2.

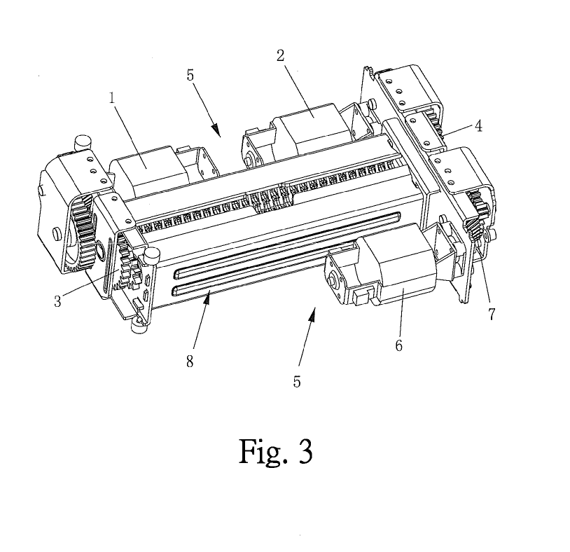

Please refer to FIG. 3 for a third preferred embodiment of the present invention. The third preferred embodiment of the present invention discloses a multiple motor paper shredder comprising a shredding mechanism 8, a first motor 1, a second motor 2, a third motor 6, a first gear assembly 3, a second gear assembly 4 and a third gear assembly 7. The shredding mechanism 8 is provided with a set of paralleling first and second rotary cutter each with multiple blades. Wherein, the first end side of the first gear assembly 3 connects to the first motor 1 and the second end side of the first gear assembly 3 connects to the first rotary cutter; the first end side of the second gear assembly 4 connects to the second motor 2 and the second end side of the second gear assembly 4 connects to the first rotary cutter; and the first end side of the third gear assembly 7 connects to the third motor 6 and the second end side of the third gear assembly 7 connects to the first rotary cutter.

The first gear assembly 3 comprising a number of gears; the second gear assembly 4 comprising a number of gears; and the third gear assembly 7 comprising a number of gears.

In this third preferred embodiment, the first gear assembly 3 and second gear assembly 4 connect to the first side of the first rotary cutter and the third gear assembly 7 connects to the second side of the first rotary cutter.

Also in this third preferred embodiment, the shredding mechanism 8 is provided with two or more motor installation spaces 5 for housing the first motor 1, second motor 2 and third motor 6

It should be appreciated that the present invention is capable of a variety of embodiments and various modifications by those skilled in the art, and all such variations or changes shall be embraced within the scope of the following claims.

1. A twin motor paper shredder comprising a shredding mechanism and a first motor and a second motor; said shredding mechanism having two sets of paralleling rotary cutters each with multiple blades; said shredding mechanism having a first and a second gear assembly installed at one side end of the said shredding mechanism; wherein, said first and second gear assembly are connects to the rotary cutters; and wherein, the shaft of said first and second motor is connected to said first and second gear assembly respectively.

2. The twin motor paper shredder as claimed in claim 1, wherein said first and second gear assembly are connect to one same said rotary cutter at the side end.

3. The twin motor system paper shredder as claimed in claim 1, wherein said first gear assembly connects to one of the said rotary cutters, and said second gear assembly connects to the other said rotary cutter.

4. The twin motor paper shredder as claimed in any of the claim 1˜3, wherein said first and second motor are installed at the same side of the said shredding mechanism.

5. The twin motor paper shredder as claimed in any of the claim 1˜3, wherein said first and second motor are installed at the opposite side of the said shredding mechanism.

6. A multiple motor power paper shredder comprising a shredding mechanism, a first motor, a second motor and at least one third motor; said shredding mechanism having a set of paralleling first and second rotary cutter each with multiple blades; said shredding mechanism haying a first, a second and at least a third gear assembly; the first end side of said first gear assembly connects to said first motor system and the second end side of said first gear assembly connects to said first rotary cutter; the first end side of said second gear assembly connects to said second motor and the second end side of said second gear assembly connects to said first rotary cutter; and the first end side of said third gear assembly connects to said third motor and the second end side of said third gear assembly connects to said first rotary cutter.

7. The multiple motor power paper shredder as claimed in claim 6 wherein, said first, second and third ear assembly all connect to the first side of said first rotary cutter.

8. The multiple motor power paper shredder as claimed in claim 6 wherein, said first and second gear connect to the first side of said first rotary cutter and said third gear assembly connects to the second side of said first rotary cutter.

9. The multiple motor power paper shredder as claimed in claim 6˜8 wherein, said shredding mechanism having at least two or more motor installation spaces for housing individually said first, second and third motor.
